(19) United States
(12) Patent Application Publication
(10) Pub. No.: US 2025/0177236 A1
(43) Pub. Date: Jun. 5, 2025

(54) APPARATUS FOR FACILITATING A MYOFASCIAL THERAPY TO A USER

(71) Applicant: MTP Ventures LLC, Cranbury, NJ (US)

(72) Inventor: Matthew Thomas Purdy, Cranbury, NJ (US)

(73) Assignee: MTP Ventures LLC, Cranbury, NJ (US)

(21) Appl. No.: 18/964,433

(22) Filed: Nov. 30, 2024

Related U.S. Application Data
(60) Provisional application No. 63/605,470, filed on Dec. 2, 2023.

(51) Int. Cl. A61H 15/02; A61H 15/00; A61H 39/04

(52) U.S. Cl. CPC A61H 15/02; A61H 39/04; A61H 2015/0014; A61H 2201/0207; A61H 2201/0257; A61H 2201/1685; A61H 2201/1692; A61H 2201/5007; A61H 2230/605

(57) ABSTRACT

The present disclosure provides an apparatus for facilitating a myofascial therapy to a user. Further, the apparatus may include a flexible membrane which may be configured to be securely wrapped around at least one portion of an object. Further, the flexible membrane includes one or more protrusions disposed on a first surface of the flexible membrane. Further, the at least one protrusion may be configured to provide a myofascial release to a user upon rolling the at least one portion of the object against a body part of the user.

### CROSS-REFERENCE TO RELATED APPLICATION

This application claims the benefit of U.S. Provisional Patent Application No. 63/605,470, titled “Adaptive Foam Wrapper for a Rollable Object”, filed on Dec. 2, 2023, which is incorporated by reference herein in its entirety.

### FIELD OF DISCLOSURE

The present disclosure generally relates to exercise devices. More specifically, the present disclosure relates to apparatus for facilitating a myofascial therapy to a user.

### BACKGROUND

The field of self-myofascial release has gained prominence for its role in improving muscle function, reducing pain, and enhancing range of motion. Traditionally, foam rollers serve as the primary tool for this purpose. However, conventional foam rollers present several challenges that restrict their utility. Foremost among these is their cumbersome size and rigid structure, which make them impractical for travel or on-the-go use. Individuals who wish to incorporate foam rolling into their daily routine, especially when away from home, find it difficult to do so owing to these limitations.

Another issue with traditional foam rollers is the lack of adaptability to different surface areas or body parts. They usually come in fixed dimensions that are not suited for application on various body parts, thereby necessitating the purchase of multiple rollers of different sizes to achieve comprehensive treatment. Moreover, traditional rollers are constructed as a single, continuous piece of material, limiting their flexibility and ability to conform to different shapes.

Additionally, the engagement between the roller and the surface on which it is applied can sometimes be unstable, causing the roller to slip or shift during use. This not only compromises the effectiveness of the self-myofascial release but also raises concerns about user safety. Some designs have attempted to address this issue by incorporating gripping materials, but these modifications often add to the bulk and complexity of the roller, and thus do not resolve the primary issue of portability.

Furthermore, the assembly and disassembly of certain existing portable designs involve the use of fasteners, snaps, or buckles, adding to the inconvenience and time required to set up or dismantle the roller for use. These fastening mechanisms can also weaken over time, diminishing the longevity of the product.

While the foam rollers are beneficial for self-myofascial release, the design constraints of existing models limit their utility and adaptability. These limitations have created a need for a more versatile, portable, and user-friendly device for self-myofascial release applications.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides an apparatus for facilitating a myofascial therapy to a user. Further, the apparatus may include a flexible membrane which may be configured to be securely wrapped around at least one portion of an object. Further, the flexible membrane includes one or more protrusions disposed on a first surface of the flexible membrane. Further, the at least one protrusion may be configured to provide a myofascial release to a user upon rolling the at least one portion of the object against a body part of the user.

The present disclosure provides an apparatus for facilitating a myofascial therapy to a user. Further, the apparatus may include a flexible membrane which may be configured to be securely wrapped around at least one portion of an object. Further, the flexible membrane includes one or more protrusions disposed on a first surface of the flexible membrane. Further, the at least one protrusion may be configured to provide a myofascial release to a user upon rolling the at least one portion of the object against a body part of the user. Further, the one or more protrusions includes two or more soft tiles.

The present disclosure provides an apparatus for facilitating a myofascial therapy to a user. Further, the apparatus may include a flexible membrane which may be configured to be securely wrapped around at least one portion of an object. Further, the flexible membrane includes one or more protrusions disposed on a first surface of the flexible membrane. Further, the at least one protrusion may be configured to provide a myofascial release to a user upon rolling the at least one portion of the object against a body part of the user. Further, a second surface of the flexible membrane opposing the first surface may be characterized by a high friction coefficient. Further, the high friction coefficient resists a movement of the flexible membrane in relation to the at least one portion of the object.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A and 3B illustrate a front view and a side view respectively of an apparatus 300 for facilitating a myofascial therapy to a user, in accordance with some embodiments.

FIG. 4A and 4B illustrate a front view and a side view respectively of the apparatus 300 for facilitating the myofascial therapy to the user, wherein the apparatus 300 may further include a fastening mechanism 402, in accordance with some embodiments.

FIG. 5A and 5B illustrate a front view and a side view respectively of the apparatus 300 for facilitating the myofascial therapy to the user, wherein the apparatus 300 may further include a fastening mechanism, in accordance with some embodiments.

FIG. 6 illustrates the apparatus 300 for facilitating the myofascial therapy to the user. Further, the apparatus 300 may further include an EMG sensor 602, in accordance with some embodiments.

FIG. 7A and 7B illustrate a front view and a side view respectively of an apparatus 700 for facilitating a myofascial therapy to a user, in accordance with some embodiments.

FIG. 8A and 8B illustrate a front view and a side view respectively of an apparatus 800 for facilitating a myofascial therapy to a user, in accordance with some embodiments.

FIG. 9A and 9B illustrate a top perspective view and a top view respectively of an apparatus 900 for facilitating a myofascial therapy to a user, in accordance with some embodiments.

FIG. 10 depicts an isometric view of the foam wrapper 1000 in its expanded form, in accordance with some embodiments.

FIG. 11 illustrates the foam wrapper 1000 in a flattened state, also shown in an isometric view, in accordance with some embodiments.

FIG. 12 illustrates a side view of the foam wrapper 1000 when expanded, in accordance with some embodiments.

FIG. 13 illustrates a side view of the foam wrapper 1000 in its flattened condition, in accordance with some embodiments.

FIG. 14 illustrates a top perspective cross-sectional view of the foam wrapper 1000, in accordance with some embodiments.

FIG. 15 illustrates the foam wrapper 1000 with a rollable object, in accordance with some embodiments.

FIG. 16A and 16B illustrate a real-world application of the foam wrapper 1000, in accordance with some embodiments.

FIG. 17 illustrates a disassembled view of the foam wrapper 1000 and its components, in accordance with some embodiments.

FIG. 18A and 18B illustrate a side view and top view respectively of the foam wrapper 1000 comprising a handle 1802, in accordance with some embodiments.

FIG. 19 illustrates an exemplary embodiment of the foam wrapper 1900 comprising the elastic substrate in the form of a mesh structure 1902 interconnected with the plurality of foam elements 1904, in accordance with some embodiments.

FIG. 20 illustrates a disassembled view of the foam wrapper 1000 provisioned as a smart device, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure relates to a foam wrapper configured to be placed over a rollable object, such as, for example, but not limited, a cylindrical object, turning the rollable object into a foam roller. The foam wrapper may include an elastic substrate, which may be a tubular structure in some embodiments, with multiple individual foam elements, such as for example, but not limited to, foam tiles affixed to an outer surface of the elastic substrate. These foam elements may be spaced apart at, for example, at regular intervals, allowing for expansion when the foam wrapper is fitted over the rollable object. In some embodiments, the foam elements may not be interconnected, providing for their independent movement upon application to the rollable object.

In some embodiments, the elastic substrate may include a fabric material that demonstrates elastic properties, allowing the elastic substrate to stretch and conform to rollable objects having different cross-sectional dimensions, such as, for example, cylindrical objects of various diameters. For example, the fabric material may be stretched when the foam wrapper is slid over a cylindrical object, causing the space between the foam elements to expand accordingly. In some embodiments, the fabric material being stretchable ensures that the foam wrapper fits snugly around the rollable object without the need for additional fasteners, snaps, or buckles.

In some embodiments, the foam wrapper may include an inner gripping material attached to an inner surface of the elastic substrate. The gripping material may provide additional friction between the foam wrapper and the rollable object, minimizing the possibility of slippage during use.

In some embodiments, a handle may be attached at the first and/or the second open end of the elastic substrate. The inclusion of the handle aids in the application and removal of the foam wrapper in relation to the rollable object, making the process more straightforward for the user.

In some embodiments, the individual foam elements affixed to the elastic substrate may feature a particular pattern or structure. The specific design or arrangement of these foam elements can vary, offering potential variations in texture or surface engagement.

In some embodiments, the foam wrapper may be configured to be flattened when not in use, providing a convenient option for storage and/or transportation. Given that traditional foam rollers are often bulky and difficult to carry, this feature offers a practical solution for those who require a more portable option.

The present disclosure provides a foam wrapper configured to be fitted over a rollable object such as, for example, but not limited to, a cylindrical object, thereby transforming the rollable object into a foam roller suitable for self-myofascial release. The foam wrapper may include an elastic substrate with a plurality of foam elements, such as tiles, affixed to an outer surface of the elastic substrate. These foam elements may be spaced apart at spatial intervals, allowing the elastic substrate to expand when the foam wrapper is applied over the rollable object. The foam elements may be individually affixed to the elastic substrate, permitting separate movement of each foam element when the foam roller is in use. The present disclosure offers several features such as an inner gripping material to minimize slippage, a handle for ease of application and removal, and optional variations in the foam elements pattern and/or structure. These aspects collectively contribute to the utility and adaptability of the foam wrapper, rendering it a versatile tool for self-myofascial release, particularly in scenarios requiring portability and ease of use. Further details, including example implementations and associated patent drawings, will be described in the subsequent sections.

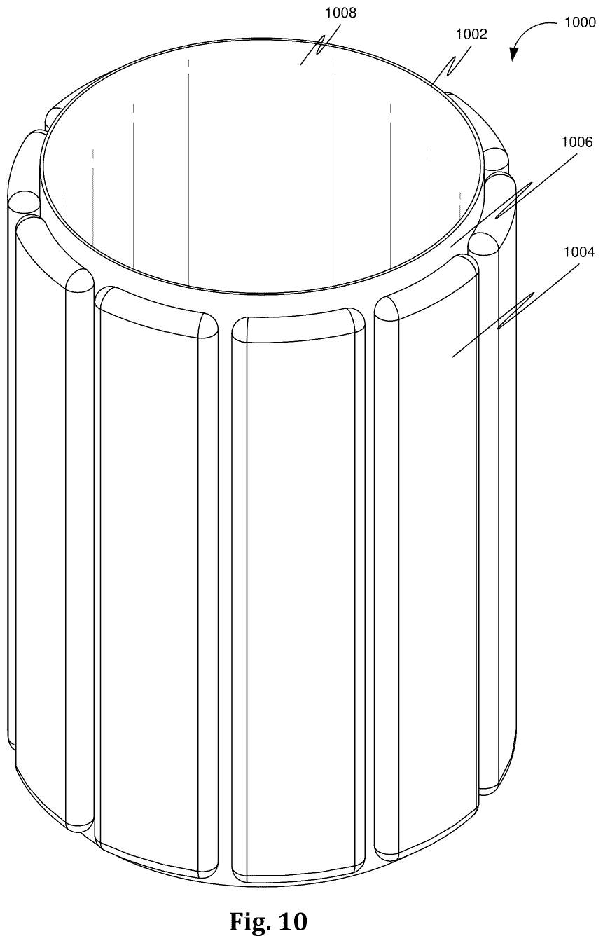

FIG. 10 depicts an isometric view of the foam wrapper 1000 in its expanded form, in accordance with some embodiments.

Accordingly, the foam wrapper 1000 is shown comprising an elastic substrate 1002 with a plurality of foam elements 1004 affixed to its outer surface 1006. The foam elements 1004 are spaced apart at, for example, regular intervals, allowing for the elastic substrate 1002 to expand. The inner surface 1008 of the elastic substrate 1002, in the present example, may be covered by a gripping material with a high frictional coefficient to ensure a firm connection to any rollable object inserted therein. In general, the rollable object may be characterized by an external shape that facilitates the rollable object to be rolled over a surface under an influence of a force. Accordingly, rolling of the rollable object may entail each of a translatory motion of the rollable object along a first axis and a rotatory movement of the rollable object along a second axis perpendicular to the first axis. Accordingly, in some embodiments, the rolling object may include an elongated body comprising a side surface and a pair of end surfaces. Further, the elongated body may be characterized by a longer axis lying along a length of the elongated body and a shorter axis perpendicular to the longer axis and lying along a breadth of the elongated body. Further, in some embodiments, the side surface may be a curved surface, as in the case of the rolling object being a cylindrical object. Accordingly, a cross-sectional profile of the elongated body may be circular, wherein the profile is perpendicular to the longer axis. In some embodiments, the cross-sectional profile may be elliptical. Further, in some embodiments, the cross-sectional profile may be polygonal such as, but not limited to, hexagonal, octagonal, decagonal, and so on. Further, the vertices of the cross-section profile may be rounded in some embodiments. Further, in some embodiments, the rolling object may include a spherical body.

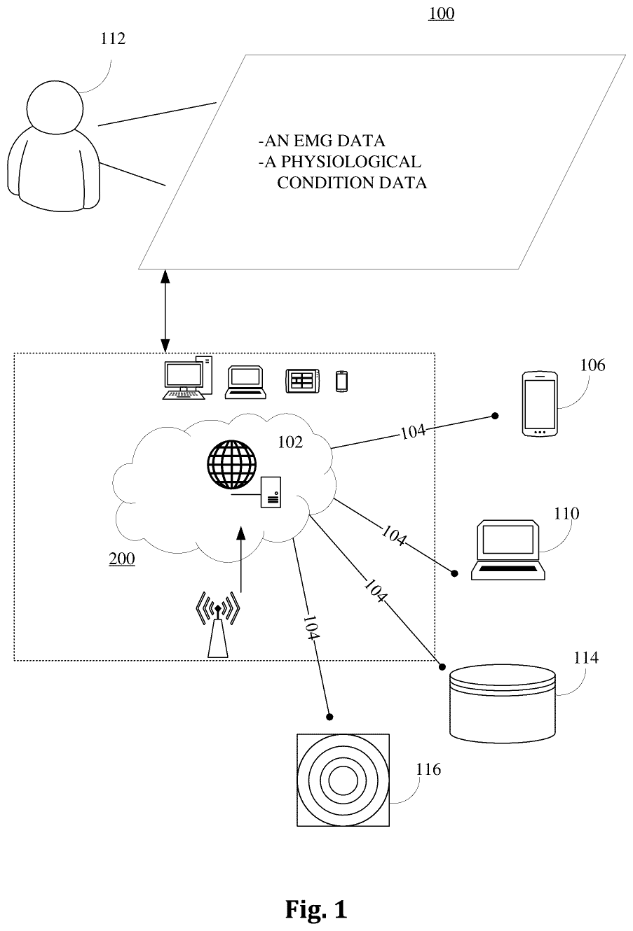

The foam wrapper 1000 can be implemented using a variety of materials for different components. For instance, the elastic substrate 1002 may be constructed from a stretchable, durable material such as spandex or elastane to provide the necessary elasticity. These materials enable the elastic substrate 1002 to adapt to rollable objects of different diameters, such as water bottles (see FIG. 1) or PVC pipes. More generally, the elastic substrate 1002 enables the foam wrapper 1000 to be snuggly installed over an external surface of the rollable object irrespective of the cross-section profile exhibited by the rolling object.

The inner gripping material, which is optional but beneficial for added friction, can be implemented using a silicone or rubber layer, or individual elements to enhance the grip between the foam wrapper 1000 and the inserted rollable object. In some embodiments, the inner material could be patterned to increase surface area and thereby augment the gripping effect.

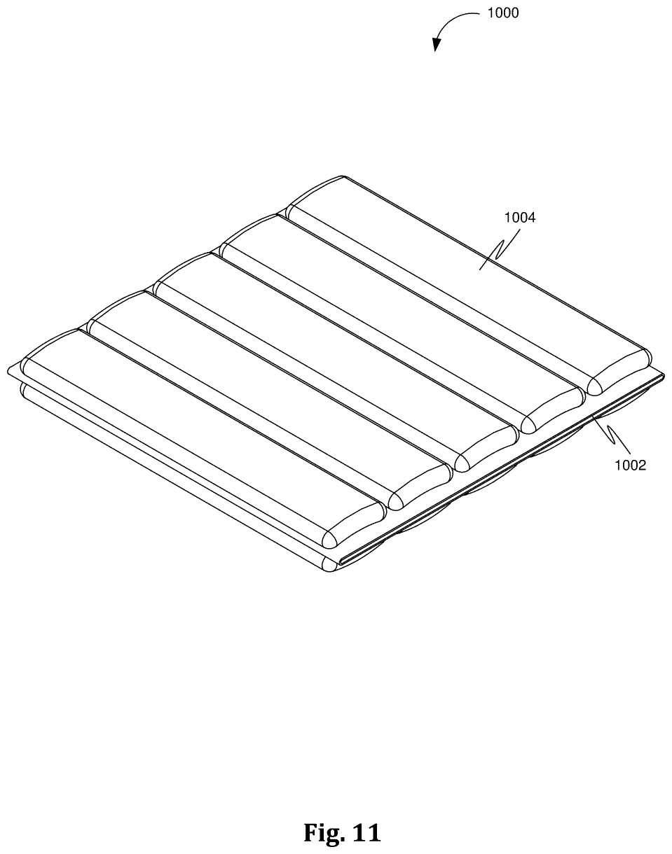

FIG. 11 illustrates the foam wrapper 1000 in a flattened state, also shown in an isometric view, in accordance with some embodiments.

Accordingly, in the flattened configuration, the elastic substrate 1002 and foam elements 1004 are visibly compressed, with minimal gaps between the foam elements 1004, highlighting the ability of the foam wrapper 1000 to be stored or transported in a flat compact form.

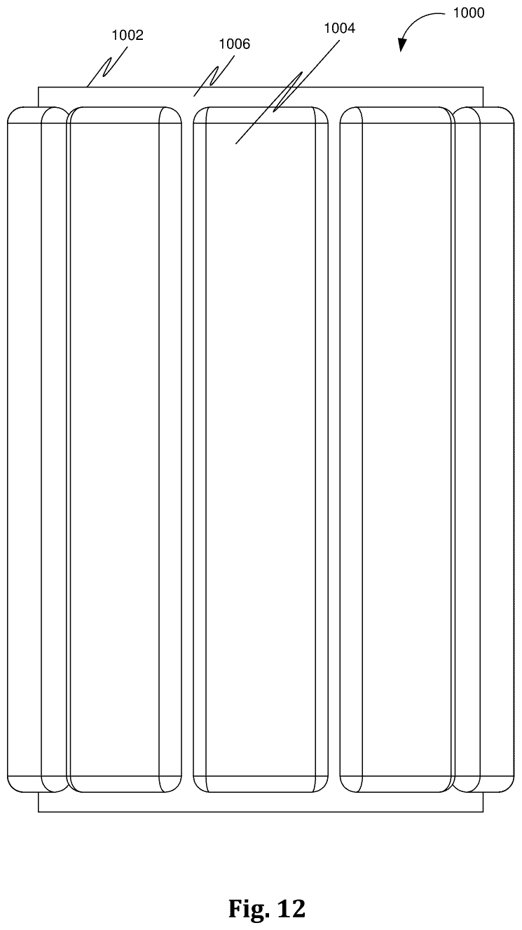

FIG. 12 illustrates a side view of the foam wrapper 1000 when expanded, in accordance with some embodiments.

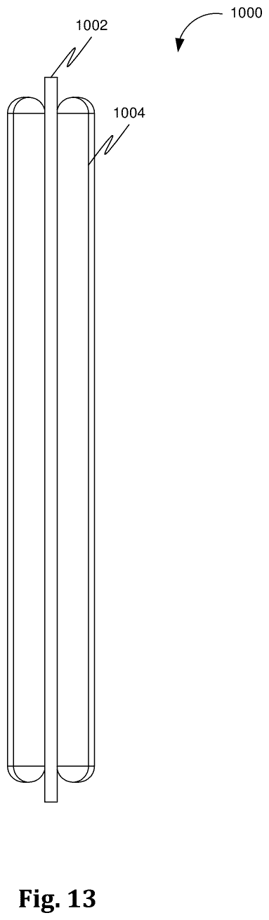

FIG. 13 illustrates a side view of the foam wrapper 1000 in its flattened condition, in accordance with some embodiments.

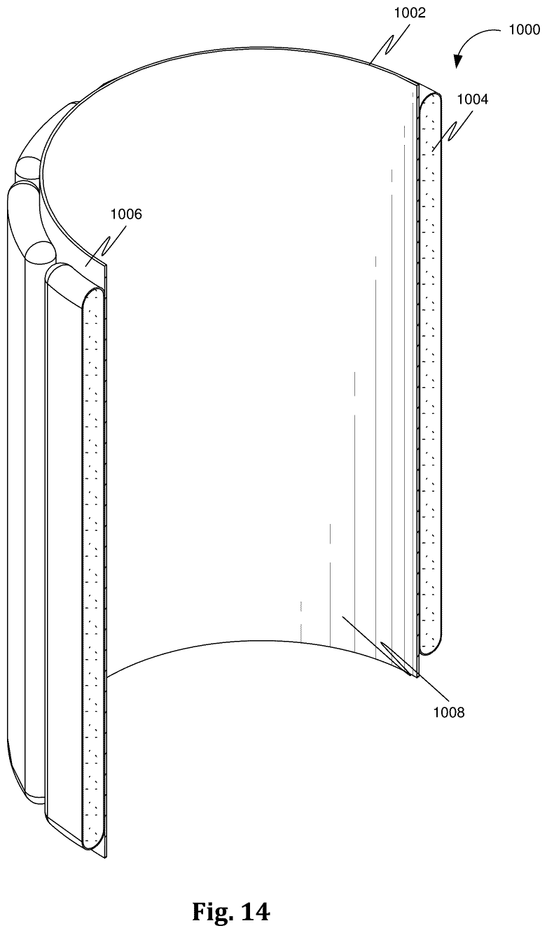

FIG. 14 illustrates a top perspective cross-sectional view of the foam wrapper 1000, in accordance with some embodiments.

Accordingly, the cross-sectional view exposes the internal structure of the foam elements 1004. The view also shows the inner gripping material attached to the inner surface 1008 of the elastic substrate 1002.

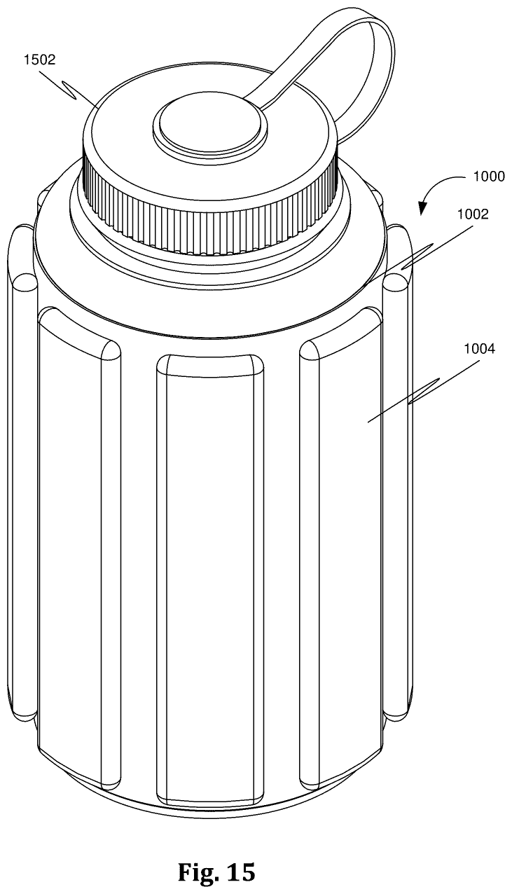

FIG. 15 illustrates the foam wrapper 1000 with a rollable object, in accordance with some embodiments.

Accordingly, in some embodiments, the rollable object may include a water bottle 1502, installed within the foam wrapper 1000. The elastic substrate 1002 is seen to stretch and conform around the water bottle 1502, causing the space between the foam elements 1004 to expand and the foam elements 1004 themselves to adapt to the rollable object's shape.

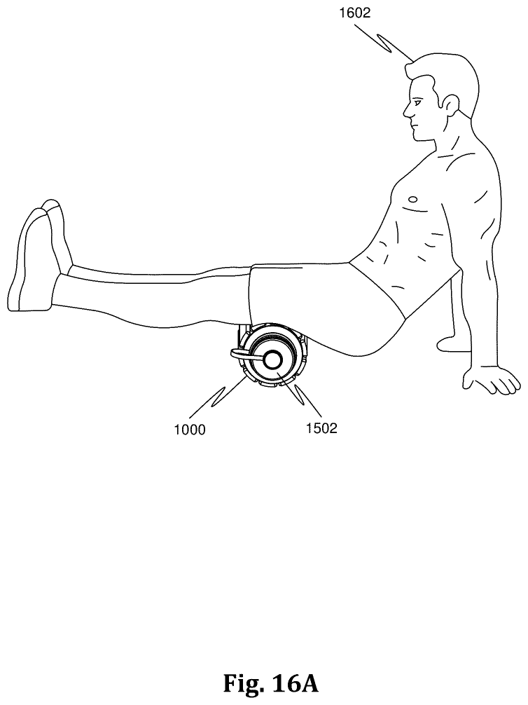

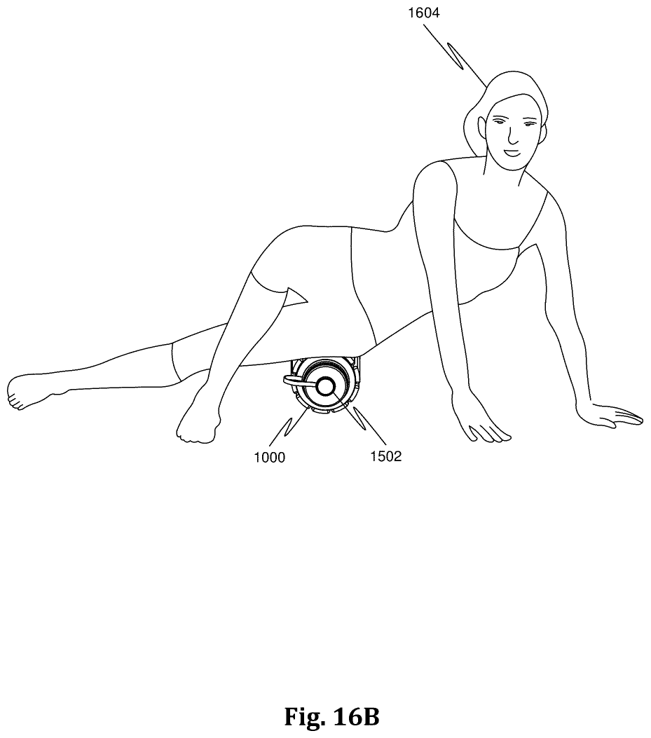

FIG. 16A and 16B illustrate a real-world application of the foam wrapper 1000, in accordance with some embodiments.

Accordingly, FIG. 16A illustrates a man 1602 using the foam wrapper 1000 fitted over the water bottle 1502 to perform a hamstring roll. FIG. 16B illustrates a woman 1604 using the foam wrapper 1000 for a hip roll, also fitted over a water bottle 1502.

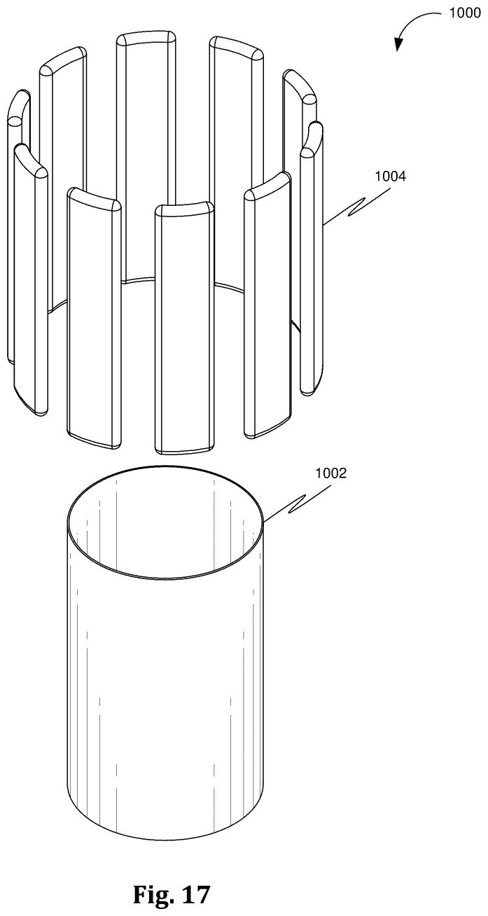

FIG. 17 illustrates a disassembled view of the foam wrapper 1000 and its components, in accordance with some embodiments.

Accordingly, the disassembled view of the foam wrapper 1000 elucidates how the individual foam elements 1004 are arranged with respect to the elastic substrate 1002. The view aids in understanding the modularity and assembly of the foam wrapper 1000, offering insights into its design and construction.

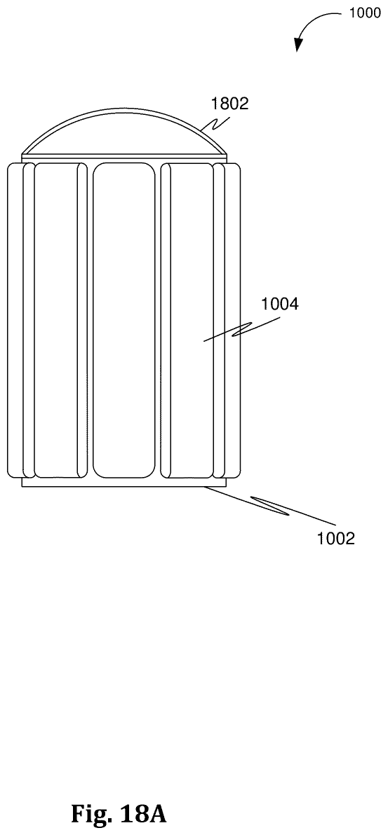

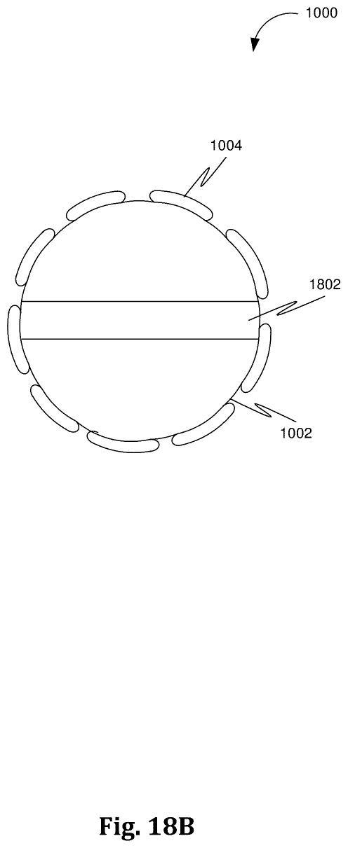

FIG. 18A and 18B illustrate a side view and top view respectively of the foam wrapper 1000 comprising a handle 1802, in accordance with some embodiments.

Accordingly, the foam wrapper 1000 may include the 1802. Further, the handle 1802 may be added at one or more ends of the elastic substrate 1002 of the foam wrapper 1000 to facilitate its application and removal from a rollable object. Further, the handle 1802 may be made from materials like nylon straps or even be an extension of the elastic substrate 1002 itself, designed for easy gripping.

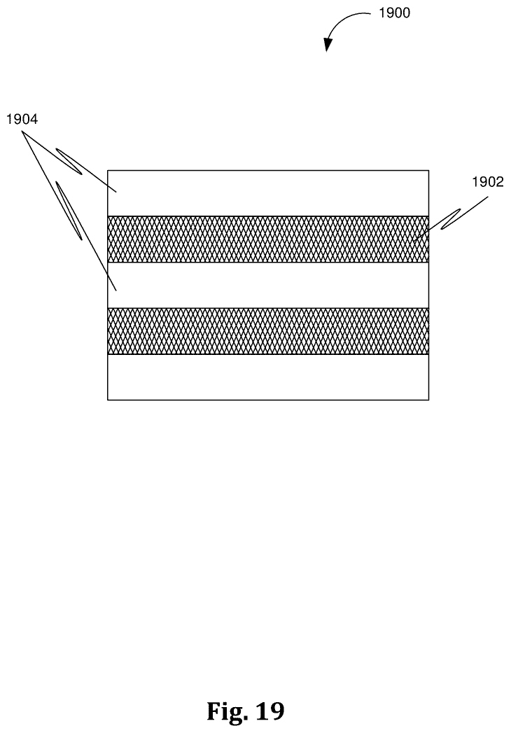

FIG. 19 illustrates a front view of a foam wrapper 1900 comprising the elastic substrate in the form of a mesh structure 1902 interconnected with the plurality of foam elements 1904, in accordance with some embodiments.

Accordingly, the plurality of foam elements 1904 may be affixed over the mesh structure 1902 which may be tubular in shape in order to facilitate the foam wrapper 1900 to be installed on the rollable object. Additionally, the plurality of foam elements 1904 may be permanently attached over the outer surface 1006 of the mesh structure 1902. Alternatively, in some embodiments, each foam element may be permanently attached to adjacent foam elements by the mesh structure 1902, thus forming a unitary structure.

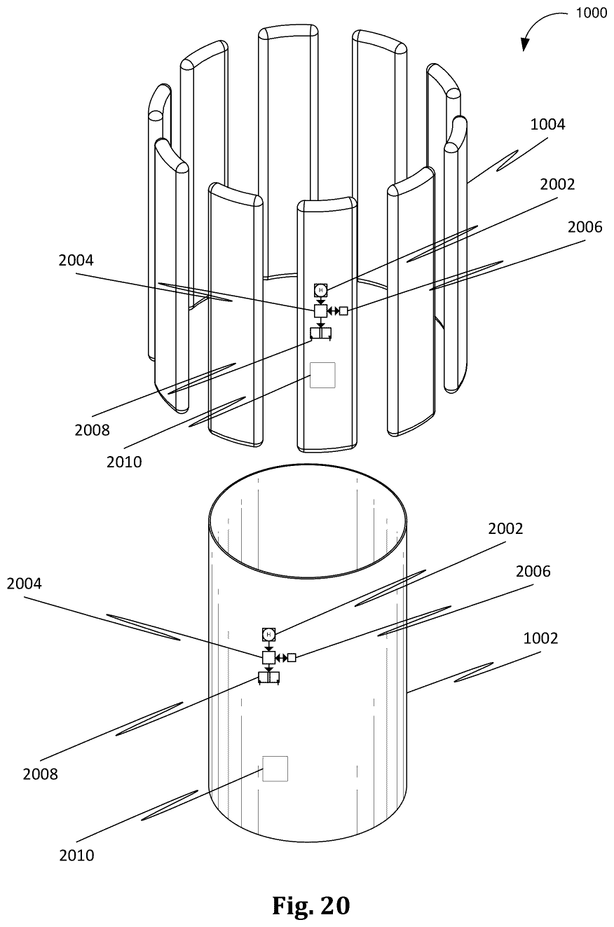

FIG. 20 illustrates a disassembled view of the foam wrapper 1000 provisioned as a smart device, in accordance with some embodiments.

Accordingly, in some embodiments, the elastic substrate 1002 may include one or more sensors 2002, such as, but not limited to, a temperature sensor, a pressure sensor, a motion sensor, a humidity sensor, an electromagnetic (EM) radiation sensor (e.g. RF receiver), a light sensor, a sound sensor, and so on. Further, the one or more sensors 2002 may be configured to generate sensor data representing a state (e.g. temperature, pressure, humidity, vibration) of the clastic substrate 1002 and/or an environmental variable in a vicinity of the elastic substrate 1002. Further, in some embodiments, the one or more sensors 2002 may be flexible (e.g. using conductive polymers, inks, and so on) and/or capable of being embedded in a fabric. Further, in some embodiments, the elastic substrate 1002 may include a processor 2004 communicatively coupled to the one or more sensors 2002, in order to process the sensor data. Further, the elastic substrate 1002 may include a memory device 2006 communicatively coupled to the processor 2004. The memory device 2006 may be configured for storing data corresponding to the state and/or the environmental variable. Further, the clastic substrate 1002 may include one or more actuators 2008 configured to generate an output signal. Examples of the one or more actuators 2008 include, but are not limited to, a light emitting device (e.g. LED), a sound emitting device (e.g. a speaker/buzzer), an EM radiation emitter (e.g. RF transmitter), and so on. Further, in some embodiments, the elastic substrate 1002 may include a power source 2010, such as for example, a flexible battery. Further, in some embodiments, the power source 2010 may include an RF receiver coil that may also be flexible and/or being capable of being embedded in the fabric. Accordingly, the RF receiver coil may receive electromagnetic radiation from an external source (e.g. RF emitter) and generate electrical power needed to operate one or more of the one or more sensors 2002, the processor 2004, the memory device 2006, and the one or more actuators 2008. Accordingly, in some embodiments, the elastic substrate 1002 may enable the foam roller to function as an IOT device. For instance, the RF emitter may enable the foam roller to communicate with an external device such as, for example, a smart phone of the user.

The foam elements 1004 affixed to the outer surface 1006 of the elastic substrate 1002 may be made of materials such as EVA foam or polyurethane. These materials offer the right blend of density and pliability, important factors for effective self-myofascial release. The foam elements 1004 could also have variations in their shapes, such as being rectangular, square, or even hexagonal, to provide different pressure points during use. Further, in some embodiments, one or more of the one or more sensors 2002, the processor 1004, the memory device 2006, the one or more actuators 2008, and the power source 2010 may be embedded in one or more of the foam elements 1004. Accordingly, the one or more sensors may be configured to sense a state (e.g. temperature, pressure, humidity, vibration) of the foam elements 1004 and/or an environmental variable in a vicinity of the foam elements 1004. As a result, a functionality of the roam roller may be enhanced, for example, by enabling monitoring of usage of the foam roller. In some embodiments, the one or more sensors 2002 may include an EMG sensor configured to sense muscular activity of the user of the foam roller. More generally, the one or more sensors 2002 may include a physiological sensor configured to sense a physiological state of the user. Accordingly, the user may obtain valuable feedback based on the usage of the foam roller.

Similarly, while the foam elements 1004 are illustrated as rectangular in the drawings, they are not limited to a particular construction. In some embodiments, the foam elements 1004 can be designed with contours or ridges to enhance the self-myofascial release experience. In other embodiments, the foam elements 1004 could include aeration holes to improve flexibility and conformability to the rollable object.

The spacing between the foam elements 1004 can also be varied. In some embodiments, the gaps between adjacent foam elements 1004 could be uniform throughout, while in others, the gaps could vary in a predetermined sequence to provide varied pressure intensities when rolled over muscle groups.

It should be noted that the foam wrapper 1000 may also be designed to accommodate rollable objects of various sizes. In some embodiments, a single foam wrapper 1000 may be dimensioned to fit rollable objects within a specified range of diameters, while in others, different sizes of foam wrappers could be produced to accommodate a broader range of rollable objects.

Further, in some embodiments, the elastic substrate 1002 may include a mesh like structure comprising a series of interconnected clastic members forming a plurality of openings there between. As a result, an overall weight of the foam wrapper 1000 may be further reduced resulting in improved portability and/or storage.

Further, in some embodiments, the foam wrapper 1000 may include a unitary structure comprised of the plurality of foam elements 1004 interspersed amongst the series of interconnected elastic members. Accordingly, in some embodiments, the plurality of foam elements 1004 may come in direct contact with an outer surface 1006 of the rollable object when the foam wrapper 1000 is installed on the rollable object for use. Accordingly, in some embodiments, a lower side of the plurality of the foam elements 1004 may include the inner gripping material.

Further, in some embodiments, the foam wrapper 1000 may be a planar sheet characterized by a length, a width, and a thickness. Accordingly, the planar sheet may comprise a pair of longer sides and a pair of shorter sides. Further, the planar sheet may include one or more fasteners disposed proximal to the pair of longer sides, such that the planar sheet may be wrapped around the rollable object and secured by means of the one or more fasteners. In some embodiments, the one or more fasteners may include, for example, a zip fastener, a snap button fastener, a Velcro fastener, a toggle fastener, a buckle fastener, and so on.

Further, in some embodiments, the inner surface 1008 of the elastic substrate 1002 may include a re-usable adhesive configured to adhere to an outer surface of the rollable object. Examples of the re-suable adhesive may include, but are not limited to, silicone adhesive, microsuction/nanosuction pads, re-usable gel adhesive static cling adhesive, and so on. Further, in some embodiments, the re-usable adhesive may be temperature sensitive (e.g. heat activated or cold activated) and/or pressure sensitive. Accordingly, a bonding state of the re-usable adhesive may depend on temperature and/or pressure being applied on the elastic substrate 1002.

Further, in some embodiments, the plurality of foam elements 1004 may be coated with a protective substance on at least an upper surface of the foam elements that may come in contact with external objects, such as a floor, while the foam roller is being used. Further, the protective substance may include, one or more of a hydrophobic substance, an oleophobic substance, an anti-static substance, an anti-microbial substance, and so on.

Further, in some embodiments, the inner surface 1008 of the elastic substrate 1002 may include an anisotropic frictional material. Accordingly, for example, a substantially greater amount of friction may be created against relative movement of the foam wrapper 1000 in relation to the rollable object in a lateral direction as opposed to a longitudinal direction. Consequently, installing and removal of the foam wrapper 1000 in relation to the rollable object may be easier for the user due to lesser friction in the longitudinal direction while preventing slippage of the foam wrapper 1000 due to movement of the foam wrapper 1000 along the lateral direction in relation to the rollable object.

Further, in some embodiments, the elastic substrate 1002 may include a shape memory polymer, such as, for example, Polyurethane Shape Memory Polymers (PUSMP), Polyethylene Shape Memory Polymers (PESMP), Polyester Shape Memory Polymers (PESMP), Polynorbornene-based SMPs, Polycaprolactone (PCL) Shape Memory Polymers, Thermoplastic Polyurethane (TPU) Shape Memory Polymers, Polyvinyl Alcohol (PVA) Shape Memory Polymers, Polysiloxane Shape Memory Polymers and so on.

Further, in some embodiments, the plurality of foam elements 1004 may include thermally conductive materials configured to absorb and/or release heat and/or maintain temperature for a long period of time. Accordingly, the foam wrapper 1000 may be warmed from a heat source (for example, using a hair dryer or filling hot water in a water bottle over which the foam wrapper 1000 is installed) and subsequently be installed on the rollable object. Likewise, in some instances, the foam wrapper 1000 may be cooled (for example, by placing within a refrigerator/freezer or filling cold water in the water bottle) and subsequently be installed on the rollable object. Consequently, use of the foam roller 1000, thus formed, may provide a therapeutic effect to the user due to the heat or coldness while being used.

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

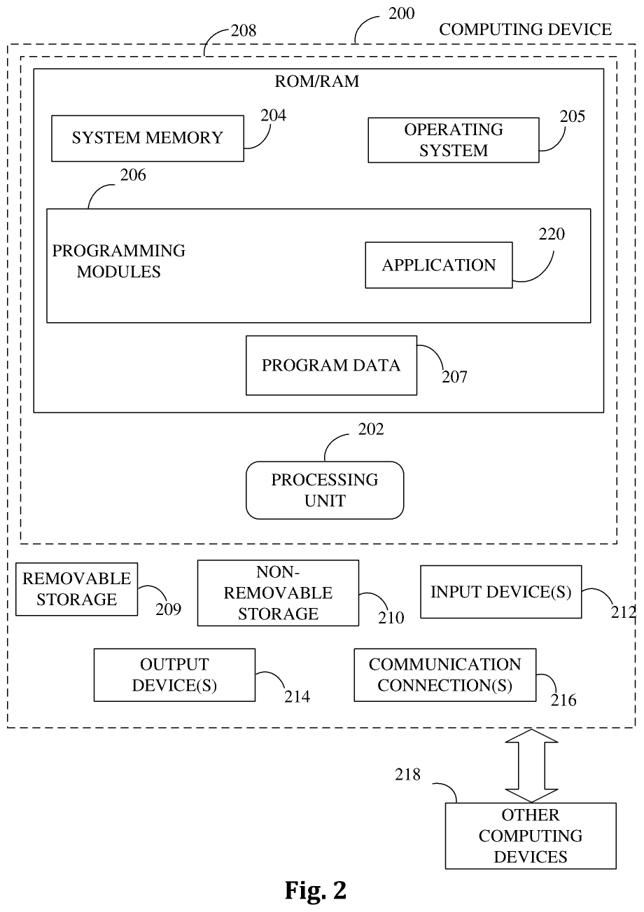

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

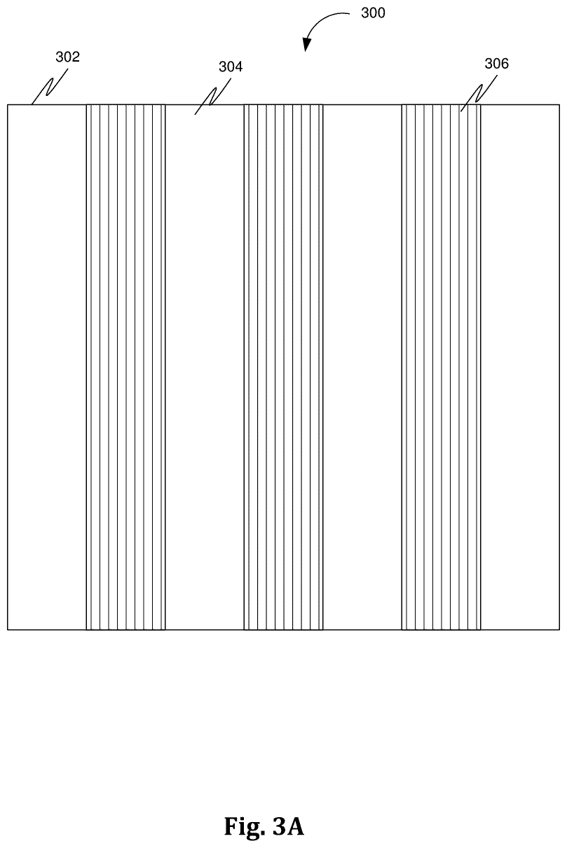

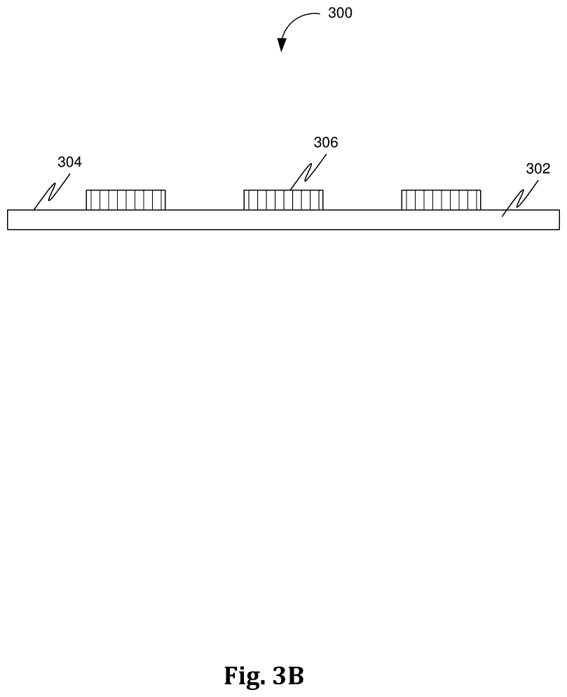

FIG. 3A and 3B illustrate a front view and a side view respectively of an apparatus 300 for facilitating a myofascial therapy to a user, in accordance with some embodiments.

Accordingly, the apparatus 300 may include a flexible membrane 302 which may be configured to be securely wrapped around at least one portion of an object.

In some embodiments, the flexible membrane 302 includes one or more of a stretchable material and a durable material. In some embodiments, the one or more of the stretchable material and the durable material includes of one or more of a spandex material, a nylon material, a polyester material, and an elastane material. In some embodiments, the flexible membrane 302 includes of a mesh structure.

In some embodiments, the object includes of one or more of a water bottle, and a PVC pipe.

Further, the flexible membrane 302 includes one or more protrusions 306 disposed on a first surface 304 of the flexible membrane 302.

In some embodiments, the one or more protrusions 306 includes two or more protrusions. Further, each of the two or more protrusions may be one or more of a uniform shape, and a uniform size.

In some embodiments, the one or more protrusions 306 includes two or more soft tiles.

In some embodiments, the two or more soft tiles includes one or more of two or more foam elements, two or more cork elements, and two or more gel elements. In some embodiments, the two or more foam elements includes one or more of an EVA foam and a polyurethane foam. In some embodiments, each of the two or more foam elements may be arranged in a specified pattern. In some embodiments, the two or more soft tiles includes of an aeration hole which may be configured to increase one or more of a flexibility and a conformability of the flexible membrane 302.

In some embodiments, the one or more protrusions 306 includes two or more foam elements affixed to the first surface 304. Further, each of the two or more foam elements may be arranged in a pattern characterized by one or more of a distance between each of the two or more foam elements, and a position of each of the two or more foam elements.

Further, the at least one protrusion 306 may be configured to provide a myofascial release to a user upon rolling the at least one portion of the object against a body part of the user.

In some embodiments, a second surface of the flexible membrane 302 opposing the first surface 304 may be characterized by a high friction coefficient. Further, the high friction coefficient resists a movement of the flexible membrane 302 in relation to the at least one portion of the object.

In some embodiments, a second surface of the flexible membrane 302 opposing the first surface 304 includes one or more of a silicone layer, a rubber layer, and an individual element layer. In some embodiments, the second surface of the flexible membrane 302 opposing the first surface 304 includes of a pattern. Further, the pattern may be configured to increase a surface of the second surface.

In some embodiments, the one or more protrusions 306 includes a shape memory polymer.

In some embodiments, the shape memory polymer includes one or more of a Polyurethane Shape Memory Polymer, a Polyethylene Shape Memory Polymer, a Polyester Shape Memory Polymer, a Polynorbornene based Shape Memory Polymer, a Polycaprolactone Shape Memory Polymer, a Thermoplastic Polyurethane Shape Memory Polymer, a Polyvinyl Alcohol Shape Memory Polymer, a Polysiloxane Shape Memory Polymer.

In some embodiments, a second surface of the flexible membrane 302 opposing the first surface 304 includes an adhesive agent which may be configured to adhere to the at least one portion of the object.

In some embodiments, the adhesive agent may be reusable.

In some embodiments, the first surface 304 of the flexible membrane 302 may be coated with a protective substance. Further, the protective substance may be configured to prevent degradation of the first surface 304.

In some embodiments, the protective substance includes one or more of a hydrophobic substance, an oleophobic substance, an anti-static substance, and an anti-microbial substance.

In some embodiments, the one or more protrusions 306 includes of a thermally conductive material which may be configured to one or more of release or absorb a heat energy. Further, the one or more of releasing and absorption of the heat energy provides a therapeutic effect to the user.

In some embodiments, the one or more protrusions 306 includes two or more foam elements affixed to the first surface 304. Further, each of the two or more foam elements may be arranged in a pattern characterized by one or more of a distance between each of the two or more foam elements, and a position of each of the two or more foam elements.

In some embodiments, the one or more protrusions 306 may be characterized by a first shape. Further, the first shape includes one or more of a cuboidal shape, a hexagonal shape, and a specified shape which may be configured to provide the myofascial release.

In some embodiments, the apparatus may further include a handle strap which may be configured to facilitate wrapping of the flexible membrane 302 around the object. Further, the handle strap includes a first end and a second end attached to the flexible membrane 302 at a same edge. In some embodiments, the first end and the second end may be diametrically opposite to each other.

Further, in some embodiments, the apparatus 300 further may include a physiological sensor which may be configured to generate a physiological data based on a physiological state of the user proximal the physiological sensor. Further, in some embodiments, the apparatus 300 further may include a processing device communicatively coupled with the physiological sensor. Further, the processing device may be configured to analyze the physiological data. Further, the processing device may be configured to generate a physiological condition data based on the analyzing. Further, the physiological data indicates a physiological condition of the user. Further, the apparatus 300 further may include a communication device communicatively coupled with the processing device. Further, the communication device may be configured to transmit the physiological condition data to a user device associated with the user.

In some embodiments, a second surface of the flexible membrane 302 opposing the first surface 304 includes of an adhesive layer which may be configured to adhere to an external surface of the object. In some embodiments, the adhesive layer includes of a silicone adhesive layer, a microsuction layer, a nanosuction layer, a gel adhesive, a pressure sensitive adhesive, and a temperature sensitive adhesive.

In some embodiments, a second surface of the flexible membrane 302 opposing the first surface 304 includes of anisotropic frictional material. Further, the anisotropic frictional material may be configured to resist a first movement of the flexible membrane 302 in relation to the object in a lateral direction upon rolling. Further, the anisotropic frictional material may be configured to allow a second movement of the flexible membrane 302 in relation to the object in a longitudinal direction.

In some embodiments, the flexible membrane 302 may be configured to be in a tubular shape. Further, the tubular shape includes an open end. Further, the object may be configured to be wrapped inside the tubular shape using the open end.

In some embodiments, the object includes of a cylindrical object.

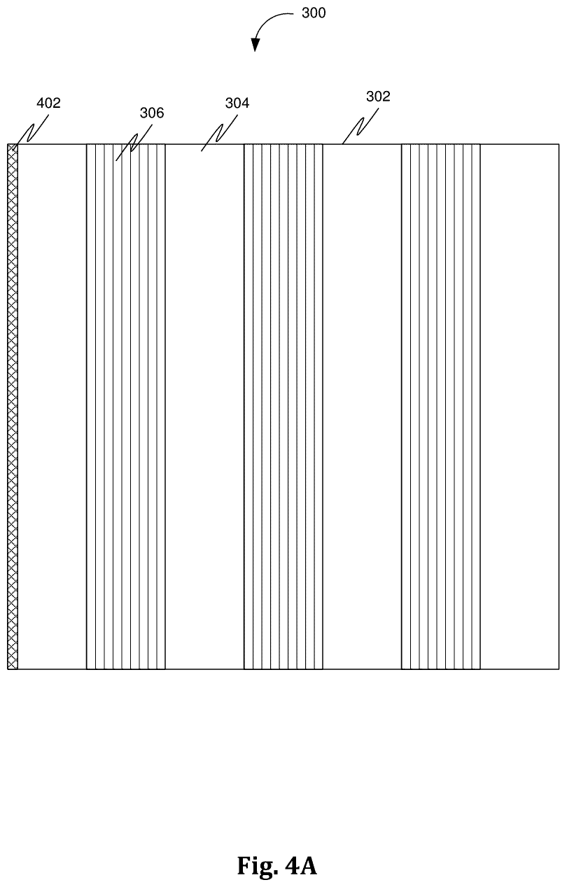

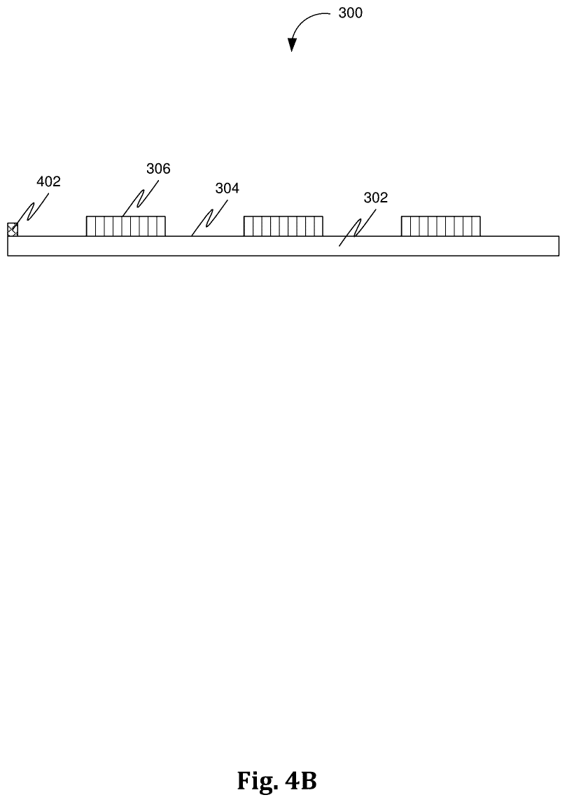

FIG. 4A and 4B illustrate a front view and a side view respectively of the apparatus 300 for facilitating the myofascial therapy to the user, wherein the apparatus 300 may further include a fastening mechanism 402, in accordance with some embodiments.

Accordingly, the apparatus 300 may further include a fastening mechanism 402 disposed on the flexible membrane 302. Further, fastening mechanism 402 may be configured to facilitate secure wrapping of the flexible membrane 302 around the object.

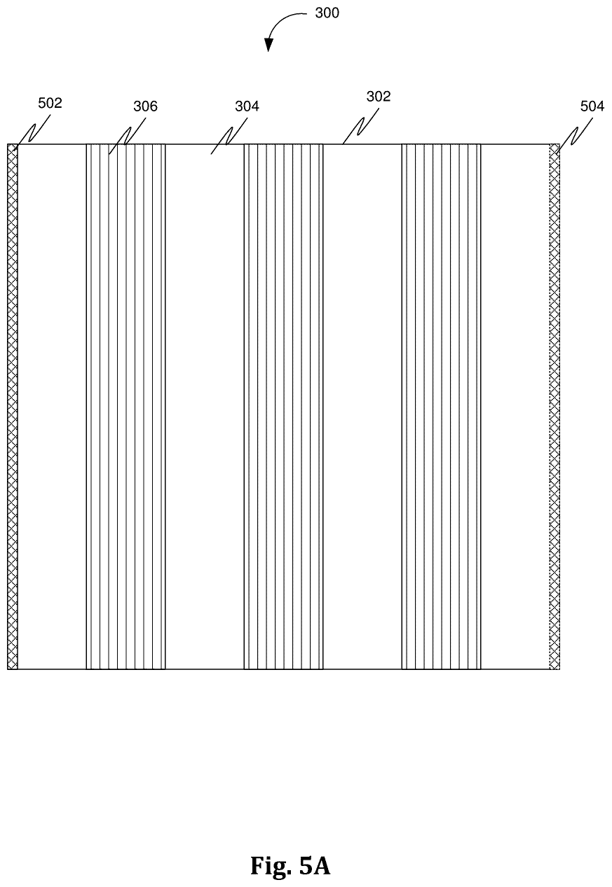

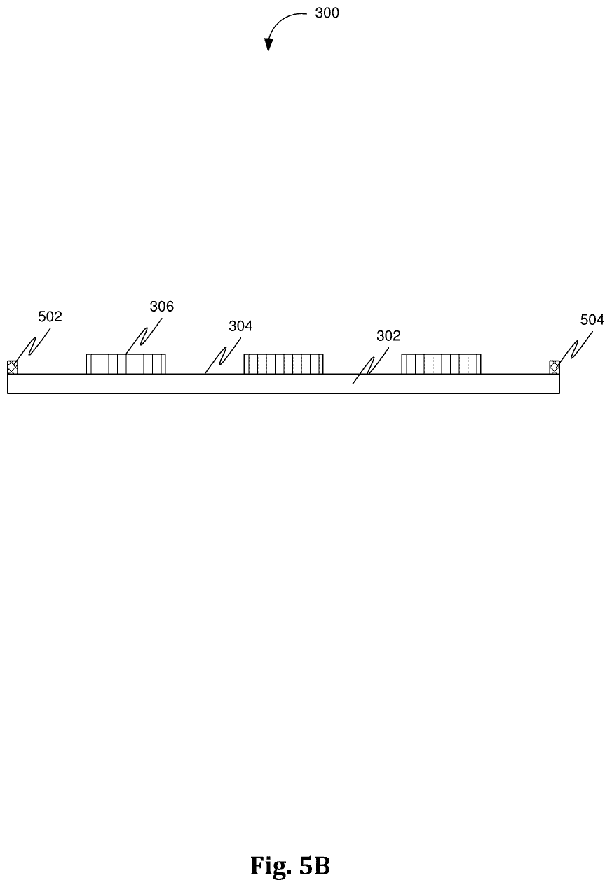

FIG. 5A and 5B illustrates a front view and a side view respectively of the apparatus 300 for facilitating the myofascial therapy to the user, wherein the apparatus 300 may further include a fastening mechanism, in accordance with some embodiments.

Accordingly, the apparatus 300 may further include a fastening mechanism disposed on the flexible membrane 302. Further, the fastening mechanism may be configured to facilitate secure wrapping of the flexible membrane 302 around the object. Further, the fastening mechanism may further include a first part 502 and a second part 504. Further, the first part 502 of the fastening mechanism 502 may be at a first edge of the flexible membrane 302. Further, a second part 504 of the fastening mechanism may be at a second edge of the flexible membrane 302. Further, the first edge and the second edge may be parallel to each other.

In some embodiments, the fastening mechanism includes one or more of a zip fastener, a snap button fastener, a Velcro fastener, a toggle fastener, and a buckle fastener.

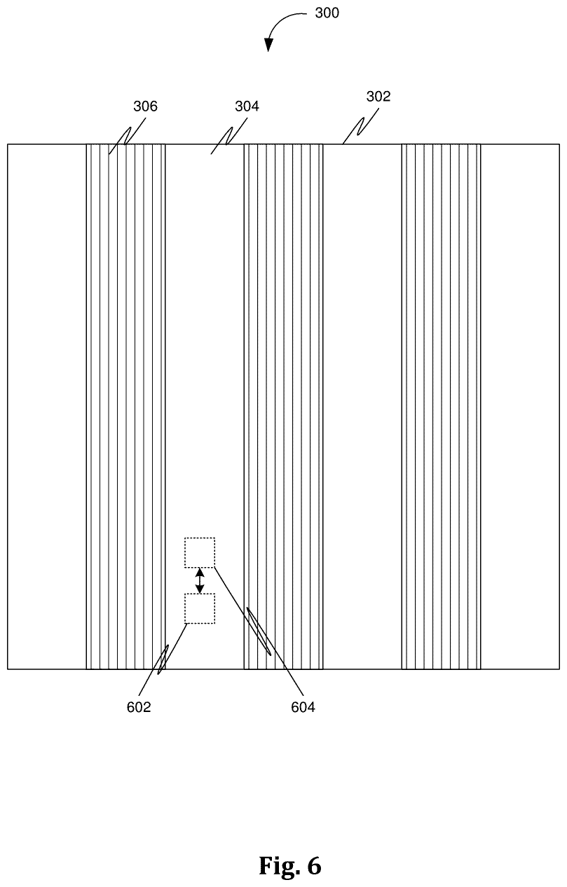

FIG. 6 illustrates the apparatus 300 for facilitating the myofascial therapy to the user. Further, the apparatus 300 may further include an EMG sensor 602, in accordance with some embodiments.

Accordingly, the apparatus 300 further may include the EMG 602 sensor which may be configured to generate an EMG data based on the muscle activity of a muscle of the user proximal to the EMG sensor 602. Further, in some embodiments, the apparatus 300 further may include a processing device 604 communicatively coupled with the EMG sensor 602. Further, the processing device 604 may be configured to analyze the EMG data. Further, the processing device 604 may be configured to generate a muscle activity data based on the analyzing. Further, the muscle activity data indicates a muscle condition after the myofascial therapy.

In some embodiments, the apparatus 300 may further include a communication device which may be configured to transmit the muscle activity data to a user device associated with the user.

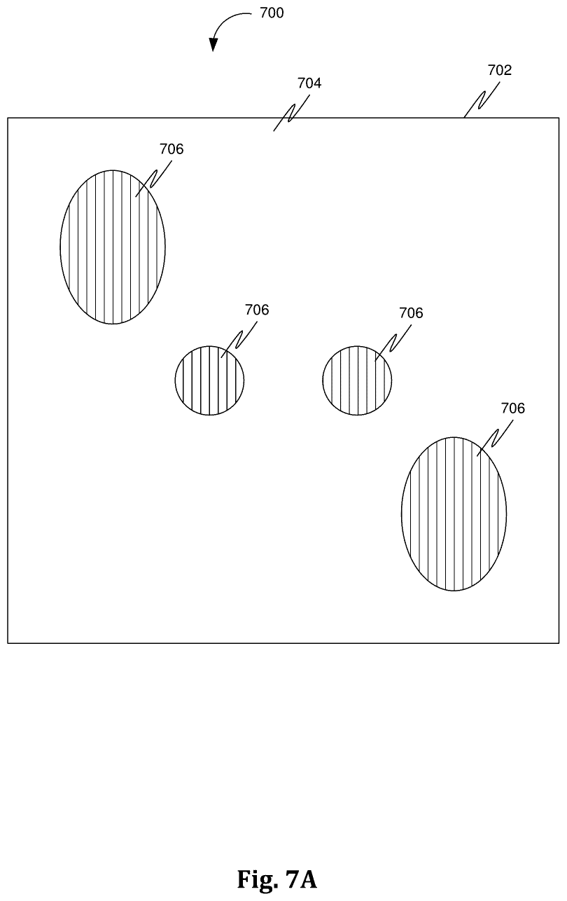

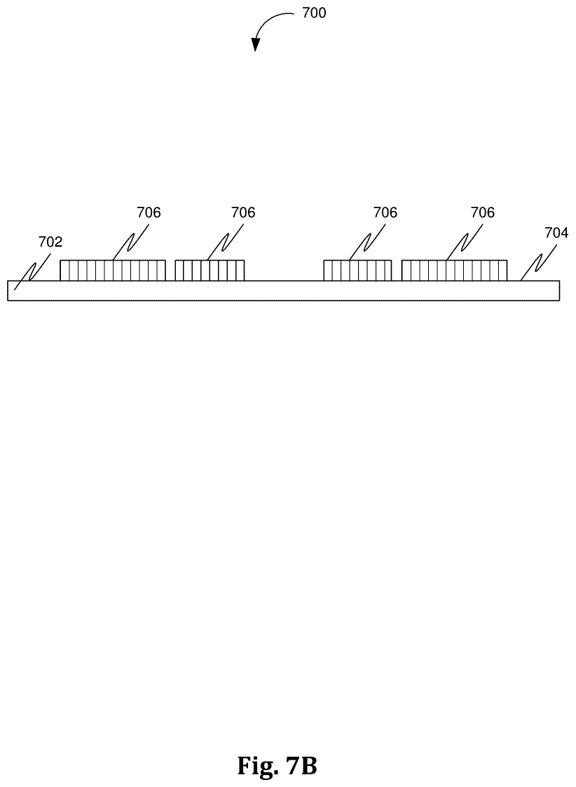

FIG. 7A and 7B illustrate a front view and a side view respectively of an apparatus 700 for facilitating a myofascial therapy to a user, in accordance with some embodiments.

Accordingly, the apparatus 700 may include a flexible membrane 702 which may be configured to be securely wrapped around at least one portion of an object. Further, the flexible membrane 702 includes one or more protrusions 706 disposed on a first surface 704 of the flexible membrane 702. Further, the at least one protrusion may be configured to provide a myofascial release to a user upon rolling the at least one portion of the object against a body part of the user. Further, in some embodiment, the one or more protrusions 706 includes two or more protrusions. Further, the each of the two or more protrusions may be disposed in accordance with a pattern. Further, the pattern indicates a predetermined sequence.

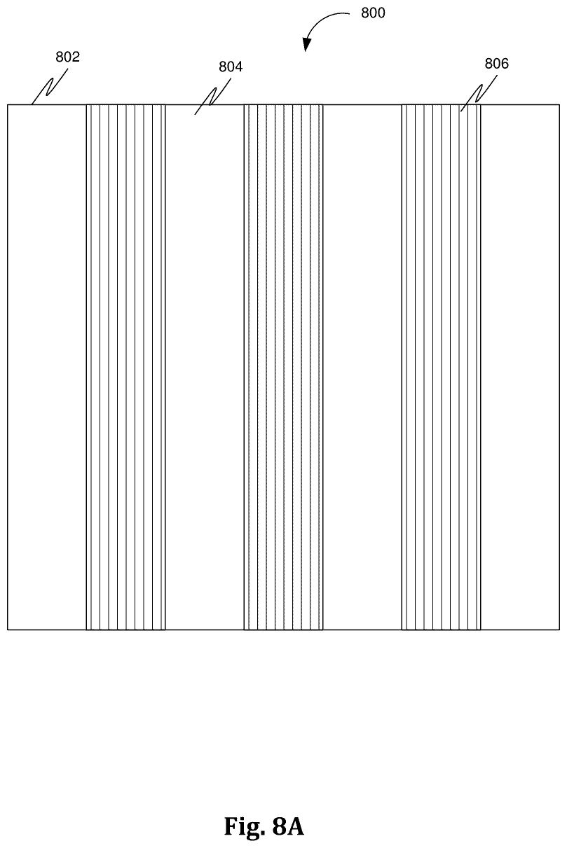

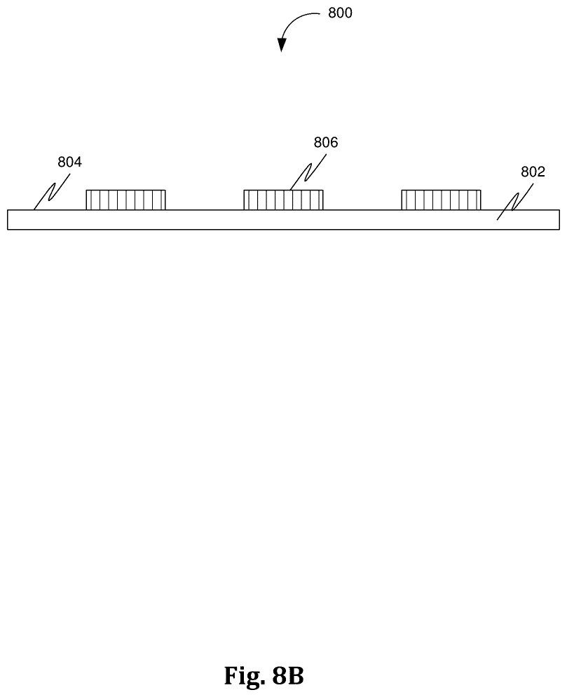

FIG. 8A and 8B illustrate a front view and a side view respectively of an apparatus 800 for facilitating a myofascial therapy to a user, in accordance with some embodiments.

Accordingly, the apparatus 800 may include a flexible membrane 802 which may be configured to be securely wrapped around at least one portion of an object. Further, the flexible membrane 802 includes one or more protrusions 806 disposed on a first surface 804 of the flexible membrane 802. Further, the at least one protrusion 806 may be configured to provide a myofascial release to a user upon rolling the at least one portion of the object against a body part of the user. Further, the one or more protrusions 806 includes two or more soft tiles.

In some embodiments, a second surface of the flexible membrane 802 opposing the first surface 804 may be characterized by a high friction coefficient. Further, the high friction coefficient resists a movement of the flexible membrane 802 in relation to the at least one portion of the object.

In some embodiments, the apparatus 800 may further include a fastening mechanism disposed on the flexible membrane 802. Further, a fastening mechanism may be configured to facilitate secure wrapping of the flexible membrane 802 around the object.

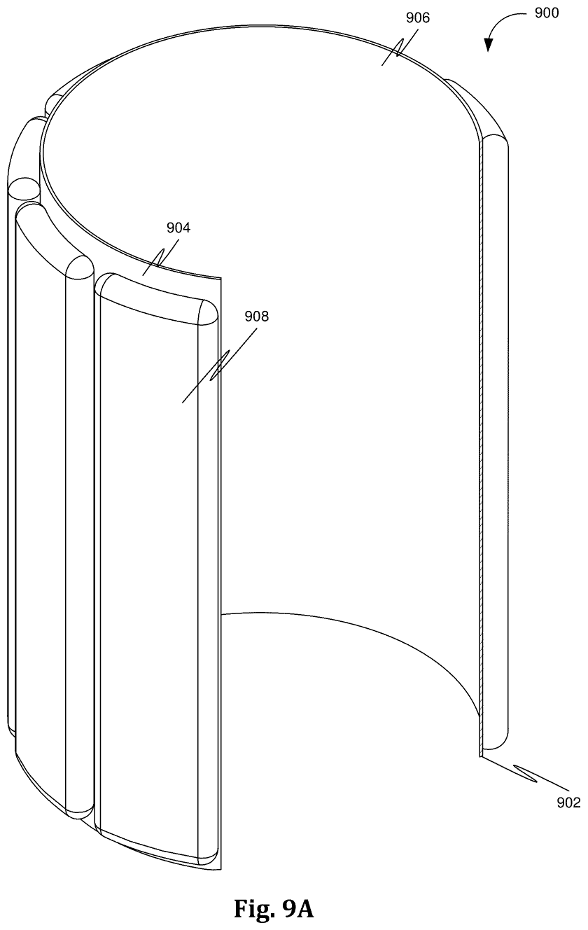

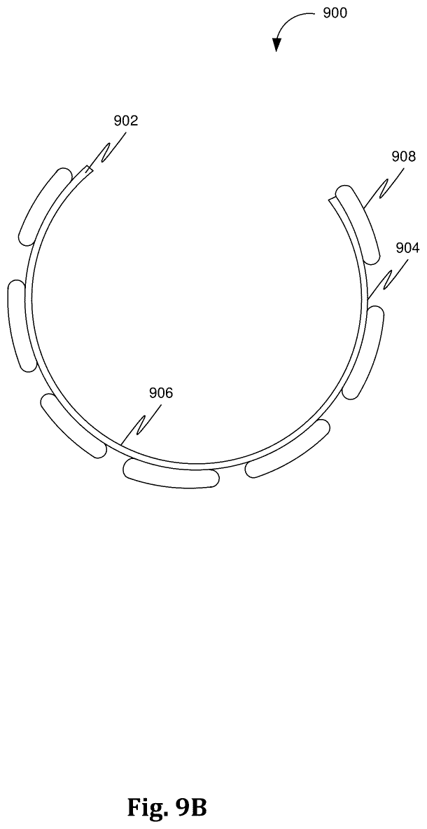

FIG. 9A and 9B illustrate a top perspective view and a top view respectively of an apparatus 900 for facilitating a myofascial therapy to a user, in accordance with some embodiments.

Accordingly, the apparatus 900 may include a flexible membrane 902 which may be configured to be securely wrapped around at least one portion of an object. Further, the flexible membrane 902 includes one or more protrusions 908 disposed on a first surface 904 of the flexible membrane 902. Further, the at least one protrusion may be configured to provide a myofascial release to a user upon rolling the at least one portion of the object against a body part of the user. Further, a second surface 906 of the flexible membrane 902 opposing the first surface 904 may be characterized by a high friction coefficient. Further, the high friction coefficient resists a movement of the flexible membrane 902 in relation to the at least one portion of the object.

In some embodiments, the one or more protrusions 908 includes two or more soft tiles.

In some embodiments, the apparatus 900 may further include a fastening mechanism disposed on the flexible membrane 902. Further, a fastening mechanism may be configured to facilitate secure wrapping of the flexible membrane 902 around the object.

Accordingly, in some embodiments, an apparatus for facilitating a myofascial therapy to a user may include a flexible membrane comprising of two or more upper edges and two or more lower edges. Further, the two or more upper edges includes of an upper inner edge and an upper outer edge. Further, the upper inner edge may be closed. Further, the upper inner edge does not include a free end. Further, the upper inner edge may be characterized by an upper inner perimeter length. Further, the upper outer edge may be closed. Further, the upper outer edge does not include a free end. Further, the upper outer edge may be characterized by an upper outer perimeter length. Further, the upper outer perimeter length may be greater than the upper inner perimeter length. Further, each of the upper inner edge and the upper outer edge lie in an upper plane. Further, the upper inner edge and the upper outer edge form an upper surface on the upper plane. Further, the upper inner edge and upper outer edge may be parallel to each other. Further, the two or more lower edges includes of a lower inner edge and a lower outer edge. Further, the lower inner edge may be closed. Further, the lower inner edge does not include a free end. Further, the lower inner edge may be characterized by a lower inner perimeter length. Further, the lower outer edge may be closed. Further, the lower outer edge does not include a free end. Further, the lower outer edge may be characterized by a lower outer perimeter length. Further, the lower outer perimeter length may be greater than the lower inner perimeter length. Further, each of the lower inner edge and the lower outer edge lie in a lower plane. Further, the lower inner edge and the lower outer edge form a lower surface on the lower plane. Further, the upper plane may be parallel to the lower plane. Further, the flexible membrane further includes two or more inner sides edges comprising an inner left side edge and an inner right side edge. Further, the inner left side edge includes an inner left upper end and an inner left lower end. Further, the inner left upper end lies on the inner upper edge. Further, the inner left lower end lies on the inner lower edge. Further, the inner right side edge includes an inner right upper end and an inner right lower end. Further, the inner right upper end lies on the inner upper edge. Further, the inner right lower end lies on the inner lower edge. Further, each of the inner left side edge and the inner right side edge may be perpendicular to the upper plane. Further, the inner left side edge may be characterized by an inner left edge length. Further, the inner right side edge may be characterized by an inner right edge length. Further, the flexible membrane further includes two or more outer sides edges comprising of an outer left side edge and an outer right side edge. Further, the outer left side edge includes an outer left upper end and an outer left lower end. Further, the outer left upper end lies on the outer upper edge. Further, the outer left lower end lies on the outer lower edge. Further, the outer right side edge includes an outer right upper end and an outer right lower end. Further, the outer right upper end lies on the outer upper edge. Further, the outer right lower end lies on the outer lower edge. Further, each of the outer left side edge and the outer right side edge may be perpendicular to the upper plane. Further, the outer left side edge may be characterized by an outer left edge length. Further, the outer right side edge may be characterized by an outer right edge length. Further, the flexible membrane further includes two or more surfaces comprising of an inner surface and an outer surface. Further, the inner surface may be bounded by the inner left side edge, the inner right side edge, the upper inner edge and the lower inner edge. Further, the outer surface may be bounded by the outer left side edge, the outer right side edge, the upper outer edge and the lower outer edge. Further, the apparatus may include two or more foam elements disposed on the outer surface of the flexible membrane. Further, each of the two or more foam elements may be of a uniform shape. Further, each of the two or more foam elements may be of a rounded cuboid shape. Further, each of the two or more foam elements may be characterized by a depth, a breadth, and a length. Further, the length may be greater than each of the depth and the breadth. Further, the breadth may be greater than the depth. Further, an axis parallel to the length of the two or more foam elements may be perpendicular to one or more of the upper plane and the lower plane. Further, the length of the each of the two or more foam elements may be in a range of 0.5-1 times of one or more of the outer left edge length and the outer right edge length. Further, each of the two or more foam elements may be parallelly separated by a distance. Further, the distance may be less than the breadth. Further, a first foam element of the two or more foam elements may be aligned with a second foam element of the two or more foam elements. Further, each of the two or more foam elements may be a solid foam tile of the rounded cuboidal shape.

Although the invention has been explained in relation to its preferred embodiment, it is to be understood that many other possible modifications and variations can be made without departing from the spirit and scope of the invention as hereinafter claimed.

### Aspects

A foam wrapper configured to fit over a rollable object, the foam wrapper comprising:
an elongated, elastic tubular substrate having a first open end and a second open end, said substrate exhibiting elastic properties;
a plurality of foam elements, each foam element affixed to an outer surface of said elongated, elastic tubular substrate at spaced-apart intervals, said intervals defining gaps there between, wherein each of said foam elements is affixed to said outer surface of said substrate, allowing for independent movement of each foam element when said foam wrapper is fitted over said rollable object.

The foam wrapper of aspect 1, further comprising an inner gripping material affixed to an inner surface of said elongated, elastic tubular substrate, said inner gripping material adapted to engage said cylindrical object to prevent slippage when said foam sleeve is fitted over said cylindrical object.

The foam wrapper of aspect 1, further comprising a handle attached to said first open end or said second open end of said elongated, elastic tubular substrate, said handle facilitating the placement and removal of said foam wrapper onto and from said rollable object.

The foam wrapper of aspect 1, wherein said foam elements exhibit a predetermined pattern or structure on said outer surface of said elongated, elastic tubular substrate.

The foam wrapper of aspect 1, wherein said fabric material comprises a material selected from the group consisting of polyester, nylon, and elastane.

The foam wrapper of aspect 1, wherein said foam elements are of a uniform size and shape.

The foam wrapper of aspect 1, wherein the substrate comprises spandex or elastane.

The foam wrapper of aspect 1, wherein the foam elements are made of EVA foam or polyurethane.

The foam wrapper of aspect 1, wherein the foam elements have contours or ridges.

The foam wrapper of aspect 1, wherein the foam elements include aeration holes.

The foam wrapper of aspect 1, wherein the gaps between adjacent foam elements are uniform.

The foam wrapper of aspect 1 is designed to fit cylindrical objects within a specified range of diameters.

The foam wrapper of aspect 1, wherein the substrate comprises a mesh structure.

The foam wrapper of aspect 1, wherein the substrate comprises a fabric sleeve.

The foam wrapper of aspect 1, wherein the rollable object comprises a cylindrical object.

The foam wrapper of aspect 1, wherein the plurality of foam elements comprises a plurality of foam tiles.

What is claimed is:

1. An apparatus for facilitating a myofascial therapy to a user, the apparatus comprising a flexible membrane configured to be securely wrapped around at least one portion of an object, wherein the flexible membrane comprises at least one protrusion disposed on a first surface of the flexible membrane, wherein the at least one protrusion is configured to provide a myofascial release to a user upon rolling the at least one portion of the object against a body part of the user.

2. The apparatus of claim 1, wherein the at least one protrusion comprises a plurality of soft tiles.

3. The apparatus of claim 1, wherein a second surface of the flexible membrane opposing the first surface is characterized by a high friction coefficient, wherein the high friction coefficient resists a movement of the flexible membrane in relation to the at least one portion of the object.

4. The apparatus of claim 1, wherein the at least one protrusion comprises a shape memory polymer.

5. The apparatus of claim 1, wherein a second surface of the flexible membrane opposing the first surface comprises an adhesive agent configured to adhere to the at least one portion of the object.

6. The apparatus of claim 1, wherein the first surface of the flexible membrane is coated with a protective substance, wherein the protective substance is configured to prevent degradation of the first surface.

7. The apparatus of claim 1 further comprises a fastening mechanism disposed on the flexible membrane, wherein the fastening mechanism is configured to facilitate secure wrapping of the flexible membrane around the object.

8. The apparatus of claim 1, wherein the at least one protrusion is characterized by a first shape, wherein the first shape comprises one or more of a cuboidal shape, a hexagonal shape, a specified shape configured to provide the myofascial release.

9. The apparatus of claim 1, wherein the object comprises of a cylindrical object.

10. The apparatus of claim 1 further comprises:
an EMG sensor configured to generate an EMG data based on the muscle activity of a muscle of the user proximal to the EMG sensor;
a processing device communicatively coupled with the EMG sensor, wherein the processing device is configured to:
analyze the EMG data;
generate a muscle activity data based on the analyzing, wherein the muscle activity data indicates a muscle condition after the myofascial therapy.

11. The apparatus of claim 1, wherein the at least one protrusion comprises of a thermally conductive material configured to one or more of release or absorb a heat energy, wherein the one or more of releasing and absorption of the heat energy provides a therapeutic effect to the user.

12. The apparatus of claim 1, wherein the at least one protrusion comprises a plurality of foam elements affixed to the first surface, wherein each of the plurality of foam elements is arranged in a pattern characterized by one or more of a distance between each of the plurality of foam elements, and a position of each of the plurality of foam elements.

13. The apparatus of claim 1, wherein a second surface of the flexible membrane opposing the first surface comprises of anisotropic frictional material, wherein the anisotropic frictional material is configured to resist a first movement of the flexible membrane in relation to the object in a lateral direction upon rolling, wherein the anisotropic frictional material is configured to allow a second movement of the flexible membrane in relation to the object in a longitudinal direction.

14. The apparatus of claim 1, wherein the flexible membrane is configured to be in a tubular shape, wherein the tubular shape comprises an open end, wherein the object is configured to be wrapped inside the tubular shape using the open end.

15. An apparatus for facilitating a myofascial therapy to a user, the apparatus comprising a flexible membrane configured to be securely wrapped around at least one portion of an object, wherein the flexible membrane comprises at least one protrusion disposed on a first surface of the flexible membrane, wherein the at least one protrusion is configured to provide a myofascial release to a user upon rolling the at least one portion of the object against a body part of the user, wherein the at least one protrusion comprises a plurality of soft tiles.

16. The apparatus of claim 15, wherein a second surface of the flexible membrane opposing the first surface is characterized by a high friction coefficient, wherein the high friction coefficient resists a movement of the flexible membrane in relation to the at least one portion of the object.

17. The apparatus of claim 15 further comprises a fastening mechanism disposed on the flexible membrane, wherein the fastening mechanism is configured to facilitate secure wrapping of the flexible membrane around the object.

18. An apparatus for facilitating a myofascial therapy to a user, the apparatus comprising a flexible membrane configured to be securely wrapped around at least one portion of an object, wherein the flexible membrane comprises at least one protrusion disposed on a first surface of the flexible membrane, wherein the at least one protrusion is configured to provide a myofascial release to a user upon rolling the at least one portion of the object against a body part of the user, wherein a second surface of the flexible membrane opposing the first surface is characterized by a high friction coefficient, wherein the high friction coefficient resists a movement of the flexible membrane in relation to the at least one portion of the object.

19. The apparatus of claim 18, wherein the at least one protrusion comprises a plurality of soft tiles.

20. The apparatus of claim 18 further comprises a fastening mechanism disposed on the flexible membrane, wherein the fastening mechanism is configured to facilitate secure wrapping of the flexible membrane around the object.
